(19) United States
(12) Patent Application Publication
(10) Pub. No.: US 2012/0072076 A1
(43) Pub. Date: Mar. 22, 2012

(54) HYBRID UTILITY VEHICLE

(75) Inventor: Roger Gustavsson, Ornskoldsvik (SE)

(73) Assignee: EL-FOREST AB, ARNASVALL (SE)

(21) Appl. No.: 13/322,517

(22) PCT Filed: May 29, 2009
(86) PCT No.: PCT/EP2009/056657

§ 371 Date: Nov. 25, 2011

(51) Int. Cl. G05D 1/00; G05D 3/00

(52) U.S. Cl. 701/41; 701/49; 180/65.275; 903/902

(57) ABSTRACT

A hybrid utility vehicle has a vehicle body and at least first and second driving wheels, each driving wheel has two wheels provided on opposite sides of the vehicle. Each of the wheels is drivable by a drive unit, whereby the speed of each wheel may be adjusted independently of the speed of the other wheels, thereby enabling adjustment of the relative position between a wheel of the first set of driving wheels (5a-b, 5e-f) and a wheel of the second set of driving wheels, and wherein the vehicle further has at least one actuator for enabling adjustment of the relative position between the first set of driving wheels and the second set of driving wheels. A method and control unit for control of the vehicle are also disclosed.

### TECHNICAL FIELD OF THE INVENTION

The present invention relates to a hybrid utility vehicle comprising a vehicle body and at least a first and a second set of driving wheels, each set of driving wheels comprising two wheels provided on opposite sides of the vehicle, wherein the first set of wheels is provided in front of the second set of wheels, wherein each of the wheels of said first and second set of driving wheels is drivable by a respective drive unit.

The present invention also relates to a method and a control unit for controlling a hybrid utility vehicle.

### TECHNICAL BACKGROUND

As a part of the ongoing effort to reduce the emissions of greenhouse gases in the atmosphere, more energy-efficient vehicles are currently being developed.

One class of such vehicles is so-called hybrid vehicles, which are provided with a drive system with a combustion engine, an electric generator/motor and an energy storage device, such as batteries or capacitors. By intelligently using the energy stored in the energy storage device, the combustion engine can be run more efficiently, which leads to a reduction in the amount of CO₂ per kilometer that is emitted by the hybrid vehicle.

There exist hybrid vehicles in the form of multi-wheel driven construction equipment and other utility vehicles. Such a hybrid vehicle is e.g. disclosed in granted Swedish patent SE 526 740. The vehicle in SE 526 740 is provided with a separate motor for each wheel so that each wheel is separately driven. In order to turn the vehicle of SE 526 740 the motors are controlled to induce a relative speed between the wheels so that selected wheels move faster than others. Although generally functioning well, there is still room for improvement with regard to the driving characteristics of the vehicle in SE 526 740.

### SUMMARY OF THE INVENTION

In view of the above, a general object of the present invention is to provide for improved driving characteristics of a multi-wheel driven utility vehicle.

According to a first aspect of the invention, these and other objects are achieved through a hybrid utility vehicle comprising a vehicle body and at least a first and a second set of driving wheels, each set of driving wheels comprising two wheels provided on opposite sides of the vehicle, wherein the first set of wheels is provided in front of the second set of wheels, wherein each of the wheels of said first and second set of driving wheels is drivable by a respective drive unit, whereby the rotational speed of each wheel may be adjusted independently of the rotational speed of the other wheels, thereby enabling adjustment of the relative position between a wheel of the first set of driving wheels and a wheel of the second set of driving wheels, and wherein the vehicle further comprises at least one actuator that is arranged and configured for enabling adjustment of the relative position between said wheel of the first set of driving wheels and said wheel of the second set of driving wheels.

A hybrid vehicle as described above may be maneuvered in alternative manners. Firstly, it is possible to control the vehicle by alternating the relative speed between a wheel of the first set of driving wheels and a wheel of the second set of driving wheels. Secondly, it is possible to control the vehicle by the at least one actuator. Controlling the vehicle through individually steering the wheels may be beneficial in terms of response time, energy-efficiency and easiness for the user. However, if one or several of the drive units may not drive its associated wheel to perform the desired movement, e.g. if a wheel slips or if it is obstructed by an object in the environment or if the vehicle is heavy loaded and the drive unit cannot drive the wheel to overcome the object or drive the wheel when it carries the heavy load or for any other reason, then the controlling capability may be diminished. Only controlling the vehicle through actuators may be heavy, i.e. require much force, it may not be that energy-efficient and the actuator, depending on the type of actuator, may have a longer response time than desired. However, in the present invention with its dual systems, the benefits of controlling the vehicle by independently alternating the speed of the wheels is present at the same time that the at least one actuator is provided to control the vehicle in case of e.g. slippage or obstruction of the wheels. Furthermore, if the wheels slip, the resistance for the actuator is lower than if the wheels are not slipping, and steering through the actuators does not require that much force.

Hence, providing a vehicle with a control system using both the relative speed of the wheels in combination with actuators, in accordance with the present invention, results in a hybrid utility vehicle in which the driving characteristics is improved as compared to previously known hybrid vehicles. Furthermore, by providing the possibility to in a secure manner alter the relative positions of the wheels of the vehicle, even if one or several of the wheels is e.g. obstructed or slip, other benefits, which will be described in greater detail below, may also be achieved.

It should be noted that the description that the first set of driving wheels is provided in front of the second set of driving wheels is as seen in the longitudinal extension of the vehicle body and as seen in the driving direction of the vehicle. Furthermore, it should be noted that the adjustment of the relative speed, inducing an adjustment of relative position, between a wheel in the first set of driving wheels and a wheel in the second set of driving wheels may be achieved in many alternative manners. It is for example possible to increase the speed of the wheel in the first set of driving wheels, or to decrease the speed of the wheel in the second set of driving wheels, or to increase or decrease the speed of both wheels but at a different rate.

The at least one actuator may, depending on the type of vehicle and the requirements of the vehicle be e.g. a respective actuator connected to some or all of the wheels of the vehicle in order to enable adjustment of the wheels independently. In other vehicles such as articulated vehicles, the at least one actuator may e.g. be one or more actuators provided to enable articulation of the vehicle around a central joint.

According to one exemplary embodiment, the vehicle further comprises a control unit, wherein the control unit is arranged and configured to receive an input signal indicative of a desired relative wheel position and in response to said input signal control at least one of said drive units to adjust the rotational speed of the wheel it is arranged to drive, in order to enable adjustment of the relative position between said wheel of the first set of driving wheels and said wheel of the second set of driving wheels, and to control the at least one actuator to alter the relative position between said wheel of the first set of driving wheels and said wheel of the second set of driving wheels.

The input signal may be initiated and dispatched from e.g. a driver of the vehicle or from a sensor such as a position indicator. Such sensors are well-known to the skilled person. For example, if a driver wants to steer the vehicle to turn towards one side, the driver may adjust steering means in the cabin which initiates a signal that is sent to the control unit. In other situations, it may be desirable that the relative wheel positions of the vehicle are adjusted as response to e.g. the surrounding environment. The signal may then be initiated from e.g. a position indicator indicating a change in a relative position between different parts of the vehicle. The control unit may then be arranged and configured to adjust the speed of at least one wheel and to adjust the at least one actuator in order to alter the relative position of the different parts of the vehicle.

According to one exemplary embodiment, the at least one actuator is a hydraulic actuator. Hydraulic actuators have proven to be beneficial in order to achieve the desired possibility of altering the relative position between a wheel of the first set of driving wheels and a wheel of the second set of driving wheels.

However, according to other exemplary embodiments, the actuator may instead be constituted of mechanical means. According to one exemplary embodiment, the mechanical means may comprise screw means that depending on how far they have been inserted into a corresponding bore alters the relative position between the wheels.

According to one exemplary embodiment, the vehicle comprises several actuators, wherein at least one actuator is associated with each wheel of the vehicle, i.e. at least one actuator is configured and arranged to alter the position of each wheel of the multi-driven vehicle. One actuator associated with one wheel provides for good possibilities of alternating the relative wheel positions. According to certain exemplary embodiments, it may be desirable to have several actuators associated with each of the wheels. This may be the situation where it is desirable to be able to alter the relative positions of the wheels in several planes.

According to one exemplary embodiment, each of the drive units is an electric motor or a hydraulic motor. Electric motors are beneficial to utilize as drive units in hybrid vehicles. Also hydraulic motors are beneficial to utilize as drive units in hybrid vehicles.

According to one exemplary embodiment, the vehicle is a vehicle in which a steering angle between at least one of the driving wheels in the first set of wheels and at least one of the driving wheels in the second set of wheels may be altered in order to affect the travel direction of the vehicle, wherein said at least one actuator is arranged and configured for adjusting said steering angle.

According to one exemplary embodiment, the vehicle is an articulated vehicle. An articulated vehicle is a vehicle with at least one pivoting joint placed between two of the sets of wheels of that vehicle. Hence, the angle between the part of the vehicle where one set of wheels is placed and a part of the vehicle where another set of wheels is places may be altered, thereby altering the angle between the two sets of wheels. The present invention may beneficially be implemented in an articulated vehicle. In that situation, when the rotational speed of a wheel is adjusted independently of the rotational speed of another wheel, thereby enabling adjustment of the relative position between a wheel of the first set of driving wheels and a wheel of the second set of driving wheels, the vehicle may turn around the pivoting joint and the steering angle is adjusted. If the drive units can not affect one or several of the wheels to perform the desired movement, the at least one actuator will be able to affect the adjustment of the steering angle.

According to another exemplary embodiment, at least one set of wheels of the vehicle is provided on a shaft, the extension of which may be altered in relation to the vehicle body. Hence, by altering the extension of the shaft, the angle between at least one of the driving wheels in the first set of wheels and at least one of the driving wheels in the second set of wheels may be altered in order to affect the travel direction of the vehicle. The present invention may beneficially be implemented in such a vehicle.

According to one exemplary embodiment, each of the wheels of at least one of the sets of wheels is pivotably connected to the vehicle body through a movable arm, wherein said pivotable connection allows the wheels of that at least one set of wheels to be, independently of each other, positioned at different positions along the length of the vehicle body, wherein the vertical position of a wheel in relation to the vehicle body is dependent on the position of that wheel along the length of the vehicle body.

This arrangement provides for an improvement of other driving characteristics than the ones mentioned above, i.e. prevention of lost steering capability when one or several wheels cannot be adjusted by the drive units, e.g. because the vehicle is heavy loaded or the wheel has come into contact with and been obstructed by an object in the environment or because of slippage. With this improvement, it is for example possible to maintain the vehicle body substantially horizontal when driving on e.g. sloped or uneven ground. Another improvement is the possibility to raise or lower the vehicle body, e.g. when a driver is to enter or exit the vehicle. Since the wheels are individually driven it is possible to decide to raise or lower one or several of the wheels of the vehicle in relation to the vehicle body. Hence, the vertical adjustment may take place by driving one of the wheels provided on a movable arm and maintain the other ones still, or to drive one wheel provided on a movable arm at a different speed than the other wheels. The position of that wheel along the vehicle body will then be changed, and so will the vertical position in relation to the vehicle body.

The movable arm may e.g. be a swing arm, which is fixed to the body in an articulated manner and at the other end fixed in an articulated manner to a wheel. The pivotable connection of the movable arm to the vehicle body is preferably pivotable around an axis that extends in a horizontal direction.

According to one exemplary embodiment, said vehicle comprises at least two actuators that are arranged and configured for independently adjusting the position of the wheels in said set of wheels in relation to the vehicle body.

It may be suitable to provide actuators that are connected to the movable arms so that the vertical position of the wheels may be adjusted even if a wheel may not be driven to its desired position by its associated drive unit. The actuators may also assist in maintaining the wheels in the desired position when no adjustment is to take place.

According to one exemplary embodiment, it is the wheels of the foremost set of wheels that are connected to the movable arms and hence, that are possible to vertically adjust in relation to the vehicle body.

According to a second aspect of the present invention, the above-mentioned and other objects are achieved through a method for controlling a hybrid utility vehicle comprising a vehicle body and at least a first and a second set of driving wheels, each set of driving wheels comprising two wheels provided on opposite sides of the vehicle, wherein the first set of wheels is provided in front of the second set of wheels, wherein each of the wheels of said first and second set of driving wheels is drivable by a respective drive unit, whereby the rotational speed of each wheel may be adjusted independently of the rotational speed of the other wheels, and wherein the vehicle further comprises at least one actuator that is arranged and configured for enabling adjustment of the relative position between said wheel of the first set of driving wheels and said wheel of the second set of driving wheels, said method comprises the steps of: acquiring an input signal indicative of a desired relative position between a wheel of the first set of driving wheels and a wheel of the second set of driving wheels; controlling at least one of the drive units associated with a wheel in the first set of driving wheels to drive that wheel with a different speed than at least one of the wheels in the second set of driving wheels, in order to achieve the desired relative position; and controlling the at least one actuator to alter the relative position between said wheel of the first set of driving wheels and said wheel of the second set of driving wheels, in order to achieve the desired relative position.

It should be noted that the method according to the present invention by no means is limited to performing the steps thereof in any particular order.

A hybrid vehicle as described above may be maneuvered in alternative manners. Firstly, it is possible to control the vehicle by alternating the relative speed between a wheel of the first set of driving wheels and a wheel of the second set of driving wheels. Secondly, it is possible to control the vehicle by the at least one actuator. Controlling the vehicle through individually steering the wheels may be beneficial in terms of response time, energy-efficiency and easiness for the user. However, if one or several of the drive units may not drive its associated wheel to perform the desired movement, e.g. if the wheel slips or if it obstructed by an object in the environment or the vehicle is heavy loaded and the drive unit cannot drive the wheel to overcome the object or drive the wheel when it carries the heavy load or for any other reason, then the controlling capability may be diminished. Only controlling the vehicle through actuators may be heavy, i.e. require much force, it may not be that energy-efficient and the actuator, depending on the type of actuator, may have a longer response time than desired. However, in the present invention which utilizes dual systems, the benefits of controlling the vehicle by independently alternating the speed of the wheels is present and so is the effect of utilizing the at least one actuator, which will control the vehicle in case of e.g. obstruction or slippage of the wheels. Furthermore, if a wheel slip, the resistance for the actuator is lower than if the wheels are not slipping, and steering through the actuators does not require that much force. By controlling both the drive units and the actuators to achieve the same desired relative wheel position, both systems will strive towards that independently of each other. This is beneficial because the at least one actuator will then be working to achieve the desired relative wheel position, and if a drive unit for any reason may not drive the wheel it is associated with to achieve the desired position, the response for the actuator will be very short, since it is already working to achieve the desired relative wheel position.

In one exemplary embodiment, the at least one actuator is a hydraulic actuator. In that case, fluid will flow through the actuator once the control unit controls the actuator to alter a relative wheel position. Hence, if a wheel cannot be driven to its desired position by its associated drive unit, there will be a flow through the hydraulic actuator and it will be able to respond quickly.

Hence, providing a method using both the relative speed of the wheels in combination with actuators, in accordance with the present invention, results in a method of controlling a hybrid utility vehicle in which the driving characteristics is improved as compared to previously known hybrid vehicles. Furthermore, by providing the possibility to in a secure manner alter the relative positions of the wheels of the vehicle, even if one or several of the wheels is obstructed or slip, other benefits, which will be described in greater detail below, may also be achieved.

It should be noted that the method step of adjusting the relative speed, inducing an adjustment of relative position, between a wheel in the first set of driving wheels and a wheel in the second set of driving wheels may be achieved in many alternative manners. It is for example possible to increase the speed of the wheel in the first set of driving wheels, or to decrease the speed of the wheel in the second set of driving wheels, or to increase or decrease the speed of both wheels but at a different rate.

According to one exemplary embodiment, the at least one actuator and the at least one drive unit is controlled to provide the same relative position between a wheel of the first set of driving wheels and a wheel of the second set of driving wheels.

According to one exemplary embodiment, the method further comprises the step of: determining said desired relative wheel position from said acquired input signal.

The input signal may be initiated and dispatched from e.g. a driver of the vehicle or from a sensor such as a position indicator. For example, if a driver wants to steer the vehicle to turn towards one side, the driver may adjust steering means in the cabin which initiates a signal that is sent to the control unit. In other situations, it may be desirable that the relative wheel positions of the vehicle are adjusted as response to e.g. the surrounding environment. The signal may then be initiated from e.g. a position indicator indicating a change in a relative position between different parts of the vehicle. The control unit may then be arranged and configured to adjust the speed of at least one wheel and to adjust the at least one actuator in order to alter the relative position of the different parts of the vehicle.

According to one exemplary embodiment, said vehicle is a vehicle in which a steering angle between at least one of the driving wheels in the first set of wheels and at least one of the driving wheels in the second set of wheels may be altered in order to affect the travel direction of the vehicle, wherein the desired relative position between a wheel of the first set of driving wheels and a wheel of the second set of driving wheels results in a desired steering angle, wherein said method further comprises the steps of: monitoring a current steering angle, and wherein the step of the controlling at least one of said drive units and controlling said at least one actuator is performed until the current steering angle is equal to the desired steering angle.

According to one exemplary embodiment, said vehicle is an articulated vehicle. An articulated vehicle is a vehicle with at least one pivoting joint placed between two of the sets of wheels of that vehicle. Hence, the angle between the part of the vehicle where one set of wheels is placed and a part of the vehicle where another set of wheels is placed may be altered, thereby altering the angle between the two sets of wheels. The method of the present invention may beneficially be implemented to control an articulated vehicle. In that situation, when the rotational speed of a wheel is adjusted independently of the rotational speed of another wheel, thereby enabling adjustment of the relative position between a wheel of the first set of driving wheels and a wheel of the second set of driving wheels, the vehicle may turn around the pivoting joint and the steering angle is adjusted. If the drive units cannot affect one or several of the wheels to perform the desired movement, the at least one actuator will be able to affect the adjustment of the steering angle. The method of controlling at least one of said drive units and said at least one actuator to alter said steering angle, has the effect that the vehicle is made to turn towards one side.

According to another exemplary embodiment, at least one set of wheels of the vehicle is provided on a shaft, the extension of which may be altered in relation to the vehicle body. Hence, by altering the extension of the shaft, the angle between at least one of the driving wheels in the first set of wheels and at least one of the driving wheels in the second set of wheels may be altered in order to affect the travel direction of the vehicle. The method of the present invention may beneficially be implemented to control such a vehicle.

According to one exemplary embodiment, the method further comprises the steps of: controlling the drive unit driving the first wheel at the side of the vehicle that is opposite the side the vehicle is to turn towards to increase the rotational speed in relation to the second wheel at the side of the vehicle that is opposite the side vehicle is to turn towards, and controlling the actuator to adjust said steering angle in such a way that the distance between the first and second wheels at the side of the vehicle that is opposite the side the vehicle is to turn towards is increased.

According to one exemplary embodiment, each of the wheels of at least one of the sets of wheels is pivotably connected to the vehicle body through a movable arm, wherein said pivotable connection allows the wheels of that at least one set of wheels to be, independently of each other, positioned at different positions along the length of the vehicle body, wherein the vertical position of a wheel in relation to the vehicle body is dependent on the position of that wheel along the length of the vehicle body, wherein the desired relative position between a wheel of the first set of driving wheels and a wheel of the second set of driving wheels results in a desired vertical position of a pivotably connected wheel in relation to the vehicle body, and wherein at least one actuator is respectively arranged and configured for enabling adjustment of the relative position between each wheel of said set of pivotably connected driving wheels and the vehicle body, wherein the method further comprises the steps of: monitoring a current vertical position between at least one of said pivotably connected wheels and the vehicle body, wherein the step of controlling at least one of said drive units and controlling said at least one actuator is performed until the current vertical position of said wheel is equal to the desired vertical position of that wheel.

This arrangement provides for an improvement of other driving characteristics than the ones mentioned above, i.e. prevention of lost steering capability when one or several wheels cannot be adjusted by their associated drive units, e.g. because the vehicle is heavy loaded or because the wheel has come into contact with and been obstructed by an object in the environment or because of slippage. With this improvement, it is for example possible to maintain the vehicle body substantially horizontal when driving on e.g. sloped or uneven ground. Another improvement is the possibility to raise or lower the vehicle body, e.g. when a driver is to enter or exit the vehicle. Since the wheels are individually driven it is possible to decide to raise or lower one or several of the wheels of the vehicle in relation to the vehicle body. Hence, the vertical adjustment may take place by driving one of the wheels provided on a movable arm and maintain the other ones still, or to drive one wheel provided on a movable arm faster than the other wheels. The position of that wheel along the vehicle body will then be changed, and so will the vertical position in relation to the vehicle body.

The movable arm may e.g. be a swing arm, which is fixed to the body in an articulated manner and at the other end fixed in an articulated manner to a wheel. The pivotable connection of the movable arm to the vehicle body is preferably pivotable around an axis that extends in a horizontal direction.

According to one exemplary embodiment, said drive units and said at least one actuator are controlled in such a way that the difference in relative position of said wheels is determined by the drive units if the wheels rotate with the speed the control unit control the drive units to drive the wheels with.

According to one exemplary embodiment, said drive units and said at least one actuator are controlled in such a way that the difference in relative position of said wheels is determined by the drive units if none of the wheels slip.

Situations in which a wheel does not rotate with the speed the control unit control the drive units to rotate the wheel with is e.g. when the vehicle is so heavy loaded that the drive unit is not capable of driving the wheel with the desired speed or if a wheel is restricted in its movement due to objects in the terrain and the drive unit is not powerful enough to overcome that object. In these and other situations where at least one wheel does not rotate with the speed the control unit controls the drive units to drive the wheels with and in situations where at least one wheel slips, it is beneficial with the dual systems, i.e. drive units and actuators. The dual systems will, as previously described, work together to achieve the desired relative positions of the wheels. When an adjustment has been made by the at least one actuator so that the wheel once again may rotate with the desired speed or does no longer slip, the relative position of said wheels will once again be determined by the drive units. The control unit continuously monitor the wheel positions and send control signals to both the drive units and the at least one actuator. Hence, the drive units and the actuator continuously work together to control the vehicle. In each situation the drive units and the actuator strive to obtain the desired wheel position and if the drive units for some reason cannot achieve the desired wheel position, the actuator affects the wheels to achieve the desired wheel position.

As explained above, it is in certain situations desirable to utilize the drive units as a primary source of adjusting the relative positions between the wheels of the vehicle and use the actuators when one or several wheels lose their grip with the ground or is restricted in its movement for any other reason. This is for example relevant when the vehicle is to turn when standing still or when it is desired to make a vertical adjustment of at least one wheel in relation to the vehicle body when the vehicle is standing still. This is because e.g. a hydraulic system as actuator, as in one exemplary embodiment, is heavily operated when the vehicle is standing still. It may therefore be difficult to adjust the relative positions of the wheels of the vehicle, e.g. in order to turn or to vertically adjust the vehicle, using only hydraulics when the vehicle is standing still. However, once one or several wheels move with an initial speed, due to the drive units, the hydraulic system is easier to operate.

Providing this may be achieved in alternative manners. It is for example conceivable with a system in which the control unit delays the signal to the actuators somewhat in relation to the signal to the drive units. It is also conceivable with a system in which there is a delay in the actuator. According to one exemplary embodiment, the at least one actuator is a hydraulic system and the drive units are electric motors or hydraulic motors. The hydraulic system has, due to the time required to build up a sufficient pressure, a somewhat slower response time than the electric motors and the delay is therefore present in the system.

According to one exemplary embodiment, the commands are sent substantially simultaneously to both said drive units and to the at least one actuator, wherein the step of controlling the at least one actuator to alter the relative position between a wheel of the first set of driving wheels and a wheel of the second set of driving wheels to achieve the desired relative position is delayed in relation to the step of controlling at least one of the drive units to drive its respective wheel with a different speed than at least one other wheel to achieve the desired relative position.

According to one alternative embodiment, the at least one actuator is instructed to perform an operation that results in the same relative wheel position as the drive units, but at a somewhat slower rate. This may e.g. be achieved by controlling the drive units to turn e.g. left at a speed of e.g. 4 m/s and to instruct the actuator to turn left at e.g. 3.9 m/s. By this, the drive units will control the vehicle but if one or more of the wheels is e.g. obstructed or slip, the at least one actuator will continue turning the vehicle, but at a somewhat slower rate. According to one exemplary embodiment, the alternative embodiment above may be combined with providing a delay, either in the control unit or in the actuator system, as discussed above.

According to a third aspect of the present invention, the above-mentioned and other objects are achieved through a control unit for a hybrid utility vehicle in accordance with the first aspect of the present invention, wherein said control unit having an input for receiving input data, and processing circuitry configured to determine a desired relative wheel position and control at least one of said drive units and the at least one actuator to adjust the relative wheel position to said desired relative wheel position.

The control unit may be provided in the form of hardware, software or a combination thereof, and the method according to the second aspect of the present invention may be embodied in hardware in the control unit, as a computer program adapted to run on a microprocessor comprised in the control unit or as a combination thereof.

According to a fourth aspect of the present invention, the above-mentioned and other objects are achieved by a computer program enabling execution of the steps of the method according to the second aspect of the present invention when run on a control unit according to the third aspect of the present invention. Such a computer program may thus be a stand-alone computer program, or an upgrade, enabling an existing computer program to execute the steps of the method according to the present invention.

### BRIEF DESCRIPTION OF THE DRAWINGS

These and other aspects of the present invention will now be described in more detail, with reference to the appended drawings showing an exemplary embodiment of the invention, wherein:

FIG. 1 schematically illustrates, in perspective view, an exemplary hybrid vehicle according to an embodiment of the present invention, in the form of a forwarder for use in forestry;

FIG. 2 schematically illustrates an embodiment of the drive system comprised in the hybrid vehicle of FIG. 1;

FIGS. 3a and 3b schematically illustrate, in top view, the hybrid vehicle turning left; and

FIGS. 4a and 4b schematically illustrate, in side and front view, a vertical adjustment of the vehicle body of the hybrid vehicle.

### DETAILED DESCRIPTION OF AN EXEMPLARY EMBODIMENT OF THE INVENTION

In the present detailed description, various embodiments of the hybrid utility vehicle, control method, control unit and drive system according to the present invention are mainly discussed with reference to a forwarder used in forestry. It should be noted that this by no means limits the scope of the present invention, which is equally applicable for use in any other hybrid vehicle, such as hybrid-powered construction equipment, including excavators and dumpers.

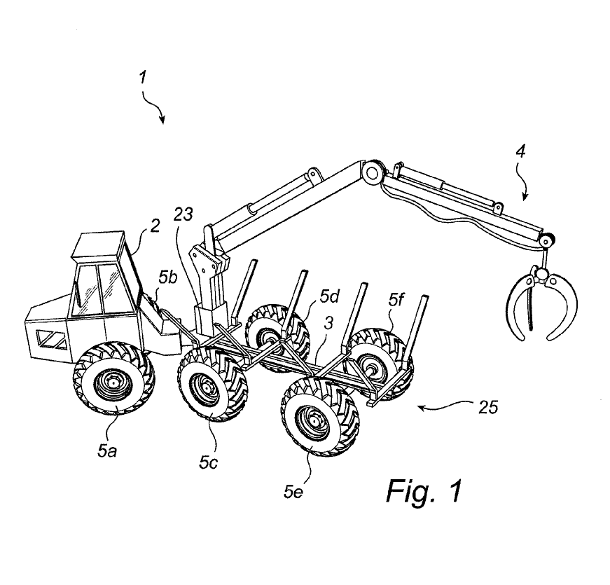

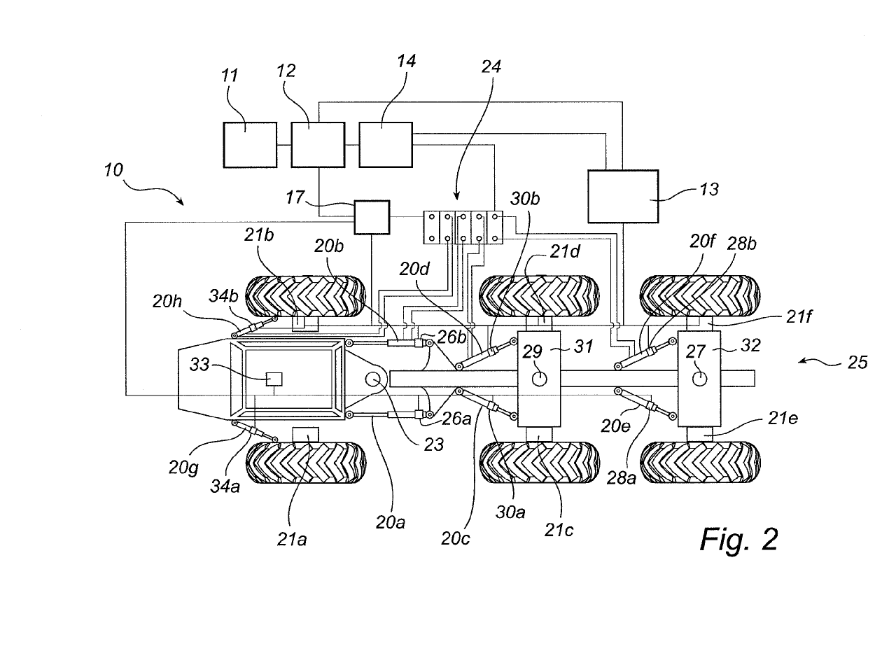

FIG. 1 schematically illustrates an exemplary hybrid vehicle in the form of a forwarder 1 for use in forestry. FIG. 2 is a block diagram schematically illustrating an embodiment of the drive system and the control means comprised in the hybrid forwarder 1 in FIG. 1.

The hybrid forwarder 1 comprises a vehicle body 25 including a cabin 2 and a bed 3 for holding harvested timber, and a hydraulic grabbing tool 4 for enabling the operator of the forwarder 1 to lift harvested timber from the ground to the bed 3 of the forwarder 1. The hybrid forwarder 1 is further provided with six wheels 5a-f, each being driven by an associated individually controllable electric motor (not shown in FIG. 1). Suitable components to be used are known to a person skilled in the art, and will not be further elaborated upon. The front wheels 5a-b of the vehicle are connected to the vehicle body through swing arms 22a-b, (not shown in FIG. 1) respectively. The electric motors driving the wheels 5a-f and the hydraulic grabbing tool 4 are powered by a drive system which is not visible in FIG. 1, but will be described in more detail below with reference to FIG. 2. The forwarder 1 also comprises actuators in the form of double-acting hydraulic cylinders 20a-h, the use of which will be described in greater detail below. The hybrid forwarder is an articulated vehicle being provided with a joint 23 between the foremost set of wheels 5a-b and the second foremost set of wheels 5c-d. The rearmost set of wheels 5e-f and the second foremost set of wheels 5c-d are each provided on a shaft 31, 32, respectively. The shafts 31, 32 are jointly connected to the vehicle body through respective joints 27, 29. In each hydraulic cylinder 20a-h is provided a respective position indicator 26a-b, 28a-b, 30a-b, 34a-b that detects the position of the cylinders and thereby the positions of the wheels of the vehicle. The vehicle also comprises a position indicator 33. The position indicator 33 is in this embodiment positioned at the bottom surface of the cabin 2 and may be a slope detecting sensor. The different types of position indicators 26a-b, 28a-b, 30a-b, 34a-b and 33 that may be employed are e.g. variable resistors or digital angle/level indicators. Another alternative is to replace the position indicators 26a-b, 28a-b, 30a-b with potentiometers provided at the respective joints 23, 27, 29 in order to detect the relative positions of the wheels of the vehicle. These and other types of position indicators that may be employed are well-known for someone skilled in the art and will therefore not be further elaborated upon.

The drive system 10 comprises a combustion engine 11, which may advantageously be provided in the form of an engine running on diesel or biofuel, an electric generator/motor 12, an energy storage device 13, here being schematically indicated by a single battery, and a hydraulic pump 14 for powering the grabbing tool 4 (not shown in FIG. 2) and the hydraulic cylinders 20a-h of the hybrid forwarder 1.

As is schematically illustrated in FIG. 2, the electric generator/motor 12 is electrically connected to the energy storage device 13, which in turn provides electric energy to the electric motors 21a-f driving the wheels 5a-f and the hydraulic pump 14 of the forwarder 1. It should be noted that the electric generator/motor 12 may also supply electric power directly to the electric motors driving the wheels 5a-f. To control operation of the drive system 10, the drive system 10 is provided with a control unit 17, which in the exemplary embodiment schematically illustrated by FIG. 2 is shown as a micro-processor associated with the electric generator/motor 12.

The control unit 17 controls both operation of the motors 21a-f and the hydraulic cylinders 20a-f. The controlling of the hydraulic cylinders 20a-f is executed through valves 24 that may be operated by the control unit 17, and which are each associated with a respective hydraulic cylinder. The control unit 17 is also connected to the position indicators 26a-b, 28a-b, 30a-b, 33, 34a-b, so that the control unit may acquire signals from them and determine the vehicles position and control the motors and hydraulic cylinders as response thereto.

In FIG. 2, only the electric motors 21b, 21d, 21f are shown connected to the control unit 17 and the energy storage device 13. This is for sake of clarity in the drawing, and the electric motors 21a, 21c, 21f are also connected to the control unit 17 and the energy storage device 13. The same is also true for the hydraulic cylinders. In FIG. 2, only the hydraulic cylinders 20b, 20d, 20f, 20g are shown connected to the valves 24 but the hydraulic cylinders 20a, 20c, 20e, 20g are also connected to the valves 24.

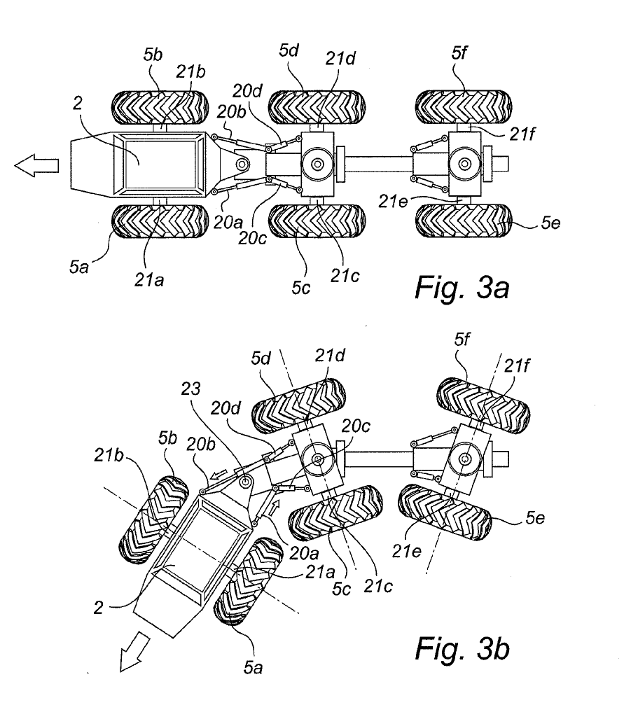

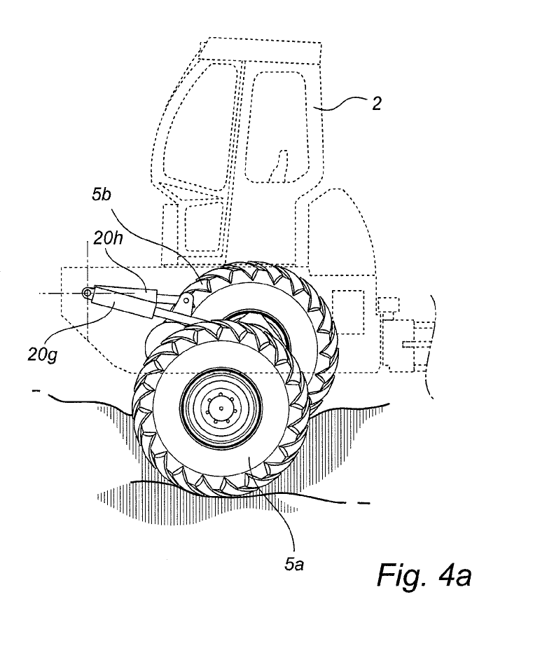

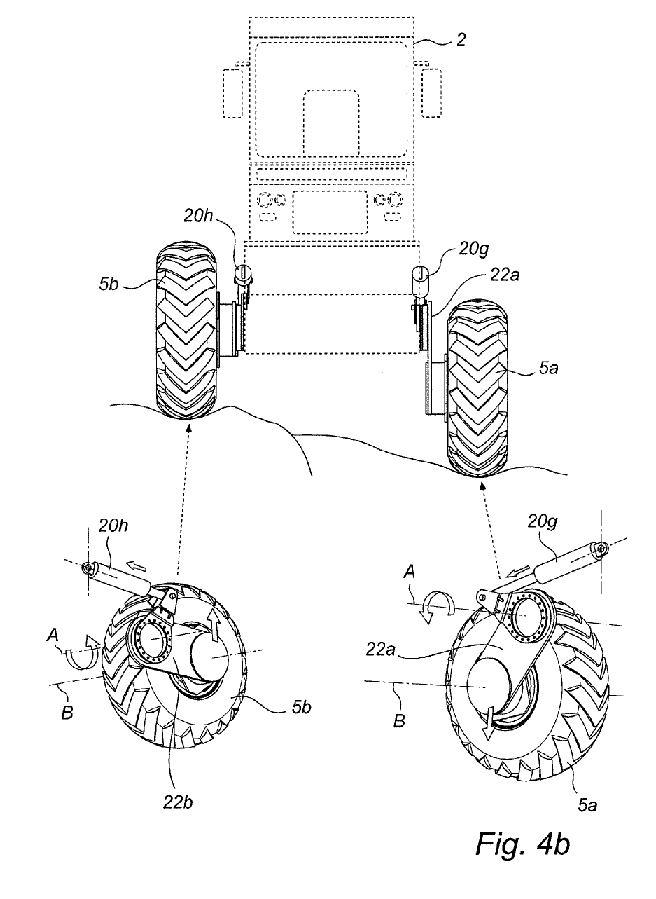

The present invention will now be described in use during different operations and with reference to FIGS. 3 and 4.

In FIGS. 3a and 3b it is illustrated how the vehicle is turned towards one side, in this case the vehicle is turning left as seen in the travel direction of the vehicle. FIG. 3a illustrates a situation where the vehicle 1 is driving straight forward in the longitudinal extension of the vehicle. As may be seen, all wheels 5a, 5c, 5e on the left side of the vehicle and all wheels 5b, 5d, 5f on the right side of the vehicle are aligned with each other. In the case where the wheels 5a-f are of the same diameter, the electric motors 21a-f associated with each one of the wheels are all driving their respective wheels with the same speed. If one or more of the sets of wheels have another diameter than the other set of wheels, the speed of the set of wheels may have to be different in order to achieve a state where the vehicle 1 is moving straight forward and maintaining the respective positions between the wheels. The hydraulic actuators 20a, 20b are also positioned so that the steering angle, i.e. the angle between the first set of wheels 5a-b, and the second set of wheels 5c-d, is 180°. When driving the vehicle and desiring to turn towards one side, e.g. to the left as illustrated in FIG. 3b, the driver will give a signal from the cabin 2 to the control unit 17 (not shown in FIG. 3) to execute the turning. The control unit 17 will acquire the signal from the driver and send a signal to the motor 21b driving the right left wheel 5b of the vehicle to increase the rotational speed of that wheel, as compared to the rotational speed of the right wheel 5d positioned behind the front right wheel 5b. Furthermore, the control unit 17 will send a signal to the motor 21c driving the second foremost left wheel 5c to increase the rotational speed of that wheel, as compared to the rotational speed of the front right wheel 5a. As a consequence the vehicle body will turn about the joint 23 and the distance between the right wheels 5b and 5d will be increased and the distance between the left wheels 5a and 5c will be decreased. By this, the steering angle between the wheels is altered and the vehicle will be made to turn.

Preferably, when initiating a turn from either standing still or driving straight forward, the difference in rotational speed between the right wheels is the same as the difference in rotational speed of the left wheels. In other words, the relative speed between front right wheel 5b and second foremost right wheel 5d is equal to the relative speed between second foremost left wheel 5c and foremost left wheel 5a. In fact, when initiating a turn, the speed of the front right wheel 5b may be equal to the speed of the second foremost left wheel 5c and the speed of the second foremost right wheel 5d may be equal to the speed of the foremost left wheel 5a.

However, once the vehicle 1 has been made to initiate the desired turn, the speed of each of the wheels will be altered again, and the speed of the right wheels 5b, 5d, 5f will be increased as compared to their corresponding left wheels 5a, 5c, 5e. The reason for this is that the right wheels 5b, 5d, 5f will travel a longer distance than the left wheels 5a, 5c, 5e and in order to avoid slippage, it is beneficial that the speed of the right wheels is higher than the speed of the left wheels. In order to continue turning the speed of the foremost right wheel 5b will still be higher than the speed of the second foremost right wheel 5d and the speed of the second foremost left wheel 5c will be higher than the speed of the foremost left wheel 5a. Preferably, the difference in rotational speed between the right wheels is the same as the difference in rotational speed of the left wheels. In other words, the relative speed between front right wheel 5b and second foremost right wheel 5d is equal to the relative speed between second foremost left wheel 5c and foremost left wheel 5a, even though the right wheels are driven with a higher speed than the left wheels. For example, when turning as quickly as possible, the speed of the outer wheels may be twice the speed of the inner wheels. The relative speed of each of the wheels is calculated and determined by the control unit 17, based on the input from position indicators 26a-b, 28a-b, 30a-b (not shown in FIG. 3). Hence, the relative speed of each wheel is continuously adjusted when the vehicle is operated, depending on signals from the driver's cabin and signals from the position indicators.

At the same time the control unit 17 controls the respective motors, it will also send a signal to the valves 24 controlling the flow of fluid to the hydraulic actuators 21a-g. In order for the vehicle to initiate a turn to the right, the valves associated with the hydraulic cylinders 21a-d will be opened so that fluid may flow to these cylinders. The cylinders are double-acting hydraulic cylinders. Hence, when fluid enters the cylinders 20a and 20c so that these are made to retract, the distance between the wheels 5a and 5c will be decreased and when fluid is made to enter the cylinders 20b and 20d so that these are made to expand, the distance between the wheels 5b and 5d will be increased. By this movement of the hydraulic cylinders, the steering angle between the foremost and second foremost wheels 5a-d is altered and the vehicle will be made to turn.

The signal may be sent simultaneously to both the motors and the hydraulic system, but there is a short delay in the hydraulic system before it affects the relative position of the wheels. This is due to the fact that it takes time to build pressure in the hydraulic cylinders. Therefore, when the vehicle is to turn, the electric motors will initiate the alteration of the steering angle, i.e. turn the vehicle, and fluid will be pumped through the hydraulic cylinders but without exerting any pressure. This is because the wheels will be made to turn by the drive units and there will therefore be no resistance from them when the actuators expand and retract. However, if one or several of the wheels cannot perform the desired adjustment, e.g. due to that the vehicle is so heavy loaded that the drive unit cannot drive the wheel with the desired speed, or that an object or unevenness in the terrain obstructs the movement of the wheel and the drive unit cannot drive the wheel to overcome that obstruction or due to slippage of a wheel, the hydraulic cylinders will, due to their respective expansion or retraction, maintain or continue to alter the steering angle and the turning will be effected even though one or several wheels are not capable of performing the desired adjustment.

In the illustrated embodiment with a six-wheeled vehicle, the rearmost set of wheels 5e-f will be controlled to act mirror-inverted in relation to the second foremost set of wheels 5c-d. Hence, if the position indicators 26a-b, 30a-b signals to the control unit 17 that the shaft 31 is inclined e.g. 10° in relation to the longitudinal extension of the vehicle body with the right wheel 5d in front of the left wheel 5c (as is illustrated in FIG. 3b), the control unit 17 will control the motors 21e-f and the hydraulic cylinders 20e-f to incline the shaft 32 10° in relation to the longitudinal extension of the vehicle body with the left wheel 5e in front of the right wheel 5f.

The turning of the vehicle has been illustrated in a situation where the vehicle is to turn left when it is moving forward. However, the same reasoning applies also when the vehicle is to turn in any other direction. For example, if turning right, the control unit will perform the same operations but mirror-inverted. If the vehicle is instead moving in the reverse direction, i.e. back-wards, the rearmost set of wheels 5e-f will be controlled and act in the manner described above for the foremost set of wheels 5a-b and the foremost set of wheels 5a-b will be controlled and act in the manner described above for the rearmost set of wheels 5e-f.

In FIGS. 4a and 4b it is illustrated how the vertical position of the cabin 2 of the vehicle may be altered. This may e.g. be beneficial when driving in sloped or uneven terrain or when entering or exiting the vehicle. As given above, the wheels 5a-b of the foremost set of wheels are each connected to the vehicle body 25 through movable arms 22a-b. The movable arms 22a-b are pivotably connected to the vehicle body 25 through double-acting hydraulic cylinders 20g-h, respectively. The hydraulic cylinders 22g-h are controlled by the control unit 17 and hold the respective wheels 5a-b in a desired position in relation to the vehicle body 25. If the hydraulic cylinders 22g-h did not do that, then the front part of the vehicle would fall to the ground due to the movable arms 22a-b.

As is best seen in FIG. 4b, each of the movable arms may rotate around a respective axis A, which is substantially horizontal. The movable arms 22a-b are also pivotably connected to the center of each of the wheels, respecttively, and may rotate around an axis B which also is substantially horizontal and extends through the center of each of the wheels 5a-b. Due to the possibility for the arms 22a-b to rotate in relation to the vehicle body 25, the vertical position of the wheels 5a-b may be adjusted in relation to the vehicle body. Hence, the vertical position of each of the wheels 5a-b in relation to the vehicle body is dependent on the position of the respective wheel along the length of the vehicle body.

In FIG. 4b, the vehicle 1 is seen from the front of the vehicle and as may be seen the left wheel 5a is positioned lower in relation to the vehicle body than the right wheel 5b. In order to achieve this adjusted vertical position of either one of the wheels, the control unit 17 controls the wheel that is to be lowered in relation to the vehicle body 25 to drive forward and at the same time controls the valves 24 so that fluid is being passed to the corresponding hydraulic cylinder. The fluid makes the cylinder, in FIG. 4 the cylinder 20g, expand and thereby effect the desired movement of the movable arm 22a. As is best seen in FIG. 4a, the left wheel 5a, that is positioned lower than the right wheel 5b in relation to the vehicle body 25, is also positioned forward of the right wheel 5b as seen in the longitudinal extension of the vehicle body.

If one desires to raise one of the wheels, the control unit instead controls the motor driving that wheel to drive it rearwards and at the same time controls the valves 24 to retract the cylinder associated with that wheel.

As described above for the turning of the vehicle, the control unit 17 may send the signal simultaneously or substantially simultaneously to the electric motor and the hydraulic system, but due to a certain delay in the hydraulic system, it is the motor that will initiate the vertical adjustment. The hydraulic system will however affect the movement of the wheel and the movable arm if the wheel starts slipping or if the electric motor for any other reason, e.g. that the movement of a wheel is obstructed, is not capable of performing the desired adjustment.

It has been illustrated how a vertical adjustment of one side of the vehicle takes place. However, performing the same operation on both of the wheels of the front set of wheels makes it possible to raise or lower the entire cabin 2 of the vehicle.

The signal to the control unit 17 to control the vertical adjustment of the vehicle body may either come from a driver in the cabin or from the position indicator 33. The position indicator 33 may, as mentioned above, be a slope detecting sensor, provided to detect that the vehicle body slopes in the longitudinal and/or transversal direction of the vehicle.

The person skilled in the art realizes that the present invention by no means is limited to the preferred embodiments described above. For example, the control unit 17 may be positioned anywhere in the hybrid vehicle 1, or may be comprised of distributed logic.

Furthermore, the present invention has been described in a six-wheel vehicle, but is equally applicable to any other multi-wheel vehicles. For example, an articulated four-wheel vehicle using the present invention will function as described above, but without operation of the rearmost set of wheels. The vehicle does also not have to be an integrated vehicle. Instead, it may be e.g. a vehicle with a trailer, wherein the wheels and actuators of the vehicle and the trailer are configured and arranged in accordance with the present invention.

Furthermore, the actuators 20g-h for effecting vertical adjustment of the vehicle body has been illustrated as extending forwards from the vehicle. However, they may be provided in other manners as well. In the disclosed embodiment, only the foremost set of wheels has been illustrated as being arranged for enabling vertical adjustment. However, it is possible to provide all wheels of the vehicle with this arrangement.

We claim:

1. A control unit for a hybrid utility vehicle comprising a vehicle body (25) and at least a first and a second set of driving wheels (5a-f), each set of driving wheels comprising two wheels provided on opposite sides of the vehicle, wherein the first set of wheels (5a-b, 5e-f) is provided in front of the second set of wheels (5c-d),
wherein each of the wheels of said first and second set of driving wheels (5a-d, 5e-f) is drivable by a respective drive unit (21a-f), whereby the rotational speed of each wheel may be adjusted independently of the rotational speed of the other wheels, thereby enabling adjustment of the relative position between a wheel of the first set of driving wheels (5a-b, 5e-f) and a wheel of the second set of driving wheels (5c-d), and
wherein the vehicle (1) further comprises at least one actuator (20a-h) that is arranged and configured for enabling adjustment of the relative position between said wheel of the first set of driving wheels (5a-b, 5e-f) and said wheel of the second set of driving wheels (5c-d), the control unit comprising:
an input for receiving input data; and
processing circuitry configured to:
determine a desired relative wheel position based on said input data;
control at least one of said drive units to adjust the relative wheel position to said desired relative wheel position; and
control the at least one actuator to adjust the relative wheel position to said desired relative wheel position in such a way that the difference in relative position of said wheels is determined by the drive units (21a-f) if none of the wheels slips.

2. The control unit according to claim 1, wherein said processing circuitry is configured to control the at least one actuator to adjust the relative wheel position to said desired relative wheel position at a slower rate as compared to the adjustment carried out by the at least one drive unit.

3. A hybrid utility vehicle (1) comprising a vehicle body (25) and at least a first and a second set of driving wheels (5a-f), each set of driving wheels comprising two wheels provided on opposite sides of the vehicle, wherein the first set of wheels (5a-b, 5e-f) is provided in front of the second set of wheels (5c-d),
wherein each of the wheels of said first and second set of driving wheels (5a-d, 5e-f) is drivable by a respective drive unit (21a-f), whereby the rotational speed of each wheel may be adjusted independently of the rotational speed of the other wheels, thereby enabling adjustment of the relative position between a wheel of the first set of driving wheels (5a-b, 5e-f) and a wheel of the second set of driving wheels (5c-d), and
wherein the vehicle (1) further comprises at least one actuator (20a-h) that is arranged and configured for enabling adjustment of the relative position between said wheel of the first set of driving wheels (5a-b, 5e-f) and said wheel of the second set of driving wheels (5c-d),
wherein the vehicle (1) further comprises the control unit (17) according to claim 1, the control unit (17) being arranged and configured to receive an input signal indicative of a desired relative wheel position and in response to said input signal control at least one of said drive units (21a-d) and the at least one actuator (20a-g) to alter the relative position between said wheel of the first set of driving wheels (5a-b, 5e-f) and said wheel of the second set of driving wheels.

4. A hybrid utility vehicle according to claim 3, wherein the at least one actuator (20a-h) is a hydraulic actuator.

5. A hybrid utility vehicle according to claim 3, wherein each of the drive units (21a-f) is an electric motor or a hydraulic motor.

6. A hybrid utility vehicle according to any one of claims claim 3, wherein the vehicle (1) is a vehicle in which a steering angle between at least one of the driving wheels in the first set of wheels (5a-b, 5e-f) and at least one of the driving wheels in the second set of wheels (5c-d) may be altered in order to affect the travel direction of the vehicle (1),
wherein said at least one actuator (20a-f) is arranged and configured for adjusting said steering angle.

7. A hybrid utility vehicle according to claim 3, wherein each of the wheels (5a-b) of at least one of the sets of wheels is pivotably connected to the vehicle body through a movable arm (22a-b),
wherein said pivotable connection allows the wheels of that at least one set of wheels to be, independently of each other, positioned at different positions along the length of the vehicle body (25), wherein the vertical position of a wheel in relation to the vehicle body (25) is dependent on the position of that wheel along the length of the vehicle body (25).

8. A hybrid utility vehicle according to claim 7, wherein said vehicle comprises at least two actuators (20g-h) that are arranged and configured for independently adjusting the position of the wheels (5a-b) in said set of wheels in relation to the vehicle body (25).

9. A method for controlling a hybrid utility vehicle comprising a vehicle body (25) and at least a first and a second set of driving wheels, each set of driving wheels comprising two wheels provided on opposite sides of the vehicle, wherein the first set of wheels (5a-b, 5e-f) is provided in front of the second set of wheels (5c-d),
wherein each of the wheels of said first and second set of driving wheels (5a-f) is drivable by a respective drive unit (21a-f), whereby the rotational speed of each wheel may be adjusted independently of the rotational speed of the other wheels, and
wherein the vehicle further comprises at least one actuator (21 a-h) that is arranged and configured for enabling adjustment of the relative position between said wheel of the first set of driving wheels (5a-b, 5e-f) and said wheel of the second set of driving wheels,
said method comprises the steps of:
acquiring an input signal indicative of a desired relative position between a wheel of the first set of driving wheels (5a-b, 5e-f) and a wheel of the second set of driving wheels (5c-d);
controlling at least one of the drive units (21a-b, 21e-f) associated with a wheel in the first set of driving wheels (5a-b, 5e-f) to drive that wheel with a different speed than at least one of the wheels in the second set of driving wheels (5c-d), in order to achieve the desired relative position, and
controlling the at least one actuator (21 a-h) to alter the relative position between said wheel of the first set of driving wheels (5a-b, 5e-f) and said wheel of the second set of driving wheels (5c-d) in such a way that the difference in relative position of said wheels is determined by the drive units (21a-f) if none of the wheels slips.

10. The method according to claim 9, wherein the method further comprises the step of:
determining said desired relative wheel position from said acquired input signal.

11. The method according to claim 9, wherein said vehicle is a vehicle in which a steering angle between at least one of the driving wheels in the first set of wheels (5a-b, 5e-f) and at least one of the driving wheels in the second set of wheels (5c-d) may be altered in order to affect the travel direction of the vehicle (1),
wherein the desired relative position between a wheel of the first set of driving wheels (5a-b, 5e-f) and a wheel of the second set of driving wheels (5c-d) results in a desired steering angle,
wherein said method further comprises the steps of:
monitoring a current steering angle, and
wherein the step of the controlling at least one of said drive units (21a-f) and controlling said at least one actuator (20a-f) is performed until the current steering angle is equal to the desired steering angle.

12. The method according to claim 9, wherein each of the wheels of at least one of the sets of wheels is pivotably connected to the vehicle body through a movable arm (22a-b),
wherein said pivotable connection allows the wheels of that at least one set of wheels to be, independently of each other, positioned at different positions along the length of the vehicle body (25),
wherein the vertical position of a wheel in relation to the vehicle body is dependent on the position of that wheel along the length of the vehicle body,
wherein the desired relative position between a wheel of the first set of driving wheels (5a-b, 5e-f) and a wheel of the second set of driving wheels results in a desired vertical position of a pivotably connected wheel in relation to the vehicle body, and wherein at least one actuator (20g-h) is respectively arranged and configured for enabling adjustment of the relative position between each wheel of said set of pivotably connected driving wheels and the vehicle body,
wherein the method further comprises the steps of:
monitoring a current vertical position between at least one of said pivotably connected wheels and the vehicle body,
wherein the step of controlling at least one of said drive units (21a-b) and controlling said at least one actuator (20g-h) is performed until the current vertical position of said wheel is equal to the desired vertical position of that wheel.

13. The method according to claim 9, wherein said drive units (21a-f) and said at least one actuator (20a-h) are controlled in such a way that the difference in relative position of said wheels is determined by the drive units (21a-f) if the wheels rotate with the speed the control unit (17) control the drive units (21a-f) to drive the wheels with.

14. (canceled)

15. The method according to claim 10, wherein said vehicle is a vehicle in which a steering angle between at least one of the driving wheels in the first set of wheels (5a-b, 5e-f) and at least one of the driving wheels in the second set of wheels (5c-d) may be altered in order to affect the travel direction of the vehicle (1),
wherein the desired relative position between a wheel of the first set of driving wheels (5a-b, 5e-f) and a wheel of the second set of driving wheels (5c-d) results in a desired steering angle,
wherein said method further comprises the steps of:
monitoring a current steering angle, and
wherein the step of the controlling at least one of said drive units (21a-f) and controlling said at least one actuator (20a-f) is performed until the current steering angle is equal to the desired steering angle.

16. The method according to claim 11, wherein each of the wheels of at least one of the sets of wheels is pivotably connected to the vehicle body through a movable arm (22a-b),
wherein said pivotable connection allows the wheels of that at least one set of wheels to be, independently of each other, positioned at different positions along the length of the vehicle body (25),
wherein the vertical position of a wheel in relation to the vehicle body is dependent on the position of that wheel along the length of the vehicle body,
wherein the desired relative position between a wheel of the first set of driving wheels (5a-b, 5e-f) and a wheel of the second set of driving wheels results in a desired vertical position of a pivotably connected wheel in relation to the vehicle body, and
wherein at least one actuator (20g-h) is respectively arranged and configured for enabling adjustment of the relative position between each wheel of said set of pivotably connected driving wheels and the vehicle body,
wherein the method further comprises the steps of:
monitoring a current vertical position between at least one of said pivotably connected wheels and the vehicle body,
wherein the step of controlling at least one of said drive units (21a-b) and controlling said at least one actuator (20g-h) is performed until the current vertical position of said wheel is equal to the desired vertical position of that wheel.

17. The method according to claim 11, wherein said drive units (21a-f) and said at least one actuator (20a-h) are controlled in such a way that the difference in relative position of said wheels is determined by the drive units (21a-f) if the wheels rotate with the speed the control unit (17) control the drive units (21a-f) to drive the wheels with.

18. A hybrid utility vehicle according to claim 4, wherein each of the wheels (5a-b) of at least one of the sets of wheels is pivotably connected to the vehicle body through a movable arm (22a-b),
wherein said pivotable connection allows the wheels of that at least one set of wheels to be, independently of each other, positioned at different positions along the length of the vehicle body (25),
wherein the vertical position of a wheel in relation to the vehicle body (25) is dependent on the position of that wheel along the length of the vehicle body (25).

19. A hybrid utility vehicle according to claim 5, wherein each of the wheels (5a-b) of at least one of the sets of wheels is pivotably connected to the vehicle body through a movable arm (22a-b),
wherein said pivotable connection allows the wheels of that at least one set of wheels to be, independently of each other, positioned at different positions along the length of the vehicle body (25),
wherein the vertical position of a wheel in relation to the vehicle body (25) is dependent on the position of that wheel along the length of the vehicle body (25).

20. A hybrid utility vehicle according to claim 6, wherein each of the wheels (5a-b) of at least one of the sets of wheels is pivotably connected to the vehicle body through a movable arm (22a-b),
wherein said pivotable connection allows the wheels of that at least one set of wheels to be, independently of each other, positioned at different positions along the length of the vehicle body (25),
wherein the vertical position of a wheel in relation to the vehicle body (25) is dependent on the position of that wheel along the length of the vehicle body (25).
